(19) United States
(12) Patent Application Publication
(10) Pub. No.: US 2024/0416753 A1
(43) Pub. Date: Dec. 19, 2024

(54) IMAGE CONTENT MODERATION SYSTEM AND METHOD FOR HYBRID RADIO BROADCAST

(71) Applicant: iBiquity Digital Corporation, Columbia, MD (US)

(72) Inventors: Paul VENEZIA, Keene, NH (US); Bob DILLON, Mendham, NJ (US)

(21) Appl. No.: 18/745,777

(22) Filed: Jun. 17, 2024

Related U.S. Application Data
(60) Provisional application No. 63/508,448, filed on Jun. 15, 2023.

(51) Int. Cl. B60K 35/29; B60K 35/28; G06T 7/00

(52) U.S. Cl. CPC B60K 35/29; B60K 35/28; G06T 7/00

(57) ABSTRACT

An image content moderation method for hybrid radio broadcast is disclosed. The method includes the steps of receiving programs along with associated metadata, such as images, through the hybrid radio broadcast on a user device. Further, the method includes the steps of analyzing the images for a potential offensive content and assigning a score to each image indicating a level of potential offensiveness. Furthermore, the method includes the steps of generating information describing the images, such that the generated information along with the corresponding scores are rendered to a user of the user device for decision making pertaining to displaying of the images. Thereafter, the method includes the steps of determining whether to display the image based at least on the selection of the user of the user device.

### CROSS-REFERENCE

This application is related to and claims priority to U.S. Provisional Application No. 63/508,448, filed on Jun. 15, 2023, and entitled “OVER-THE-AIR (OTA) RADIO BROADCAST PROGRAMMING RECOMMENDATIONS”, which is hereby incorporated by reference in its entirety.

### BACKGROUND

### Technical Field

The present disclosure relates to the field of media broadcasting, and particularly relates to an image content moderation system and method for hybrid radio broadcast.

### Description of the Related Art

Hybrid radio broadcasting is an advanced form of radio transmission that combines traditional analog signals with digital content delivery. This technology allows broadcasters to enrich the radio listening experience by transmitting supplementary digital information alongside conventional audio broadcasts. Such digital content can include text, images, and even videos, providing listeners with additional context and interactive elements related to the audio content they are consuming.

With the rise of hybrid radio, there has been a notable shift in how audiences interact with radio broadcasts. Listeners now expect a more engaging and immersive experience, which includes visual elements that enhance the overall content delivery. However, the integration of visual content into radio broadcasts introduces new challenges, particularly concerning the nature of the images that are transmitted to listeners' devices. One of the significant challenges in hybrid radio broadcasting is the potential dissemination of offensive or inappropriate images. Unlike traditional audio-only broadcasts, the hybrid radio can deliver visual content directly to users' devices, such as car infotainment systems, smartphones, and smart home devices. This visual content can originate from various sources, including direct feeds from broadcasters and third-party image catalogs. The core issue arises from the lack of control over the nature and appropriateness of these images. Offensive images, which may include explicit content, violent imagery, or hate symbols, can inadvertently be transmitted to a wide audience, including children and other vulnerable groups. This situation poses a serious risk of exposure to undesirable content, leading to discomfort, distress, and potential harm to listeners.

Therefore, there is a need for image content moderation system and method for hybrid radio broadcast that overcomes the above-mentioned drawbacks.

### BRIEF SUMMARY

One or more embodiments are directed to an image content moderation system, method, and a computer program product (hereinafter may also be termed “mechanism”) for hybrid radio broadcast. The disclosed mechanism in the present disclosure provides a sophisticated image content moderation solution tailored for hybrid radio broadcasts, addressing the critical need to ensure that visual content transmitted alongside audio broadcasts remains appropriate and non-offensive for all users. The disclosed mechanism is designed to seamlessly integrate with existing broadcast transmissions, collecting programs and associated metadata, including images, which are then transmitted to user devices such as car infotainment systems, smartphones, and smart home devices. Upon receiving these images, the disclosed mechanism employs advanced machine learning and image recognition techniques to meticulously analyze the content for potential offensiveness. This comprehensive analysis categorizes images based on various criteria, such as racy or explicit material, violence, and hate symbols. Each image is assigned a score reflecting its level of potential offensiveness, which is included as corresponding information. Such corresponding information along with the score may be rendered to the user to allow or block the display of the corresponding image. Additionally, or alternatively, the disclosed mechanism also facilitates the users to set a moderation threshold according to their personal content filtering preferences which is then used to automatically determine whether to display, block, or replace the images. In cases where an image is deemed potentially offensive, the disclosed mechanism can provide a non-offensive substitute image, ensuring that users receive appropriate content. The disclosed mechanism operates in real-time, ensuring that the content moderation process does not introduce significant delays, thus maintaining the seamless delivery of hybrid radio broadcasts.

An embodiment of the present disclosure discloses the image content moderation system for hybrid radio broadcast. The image content moderation system includes a receiver module to receive one or more programs along with associated metadata through hybrid radio broadcast on a user device. The received metadata includes at least one or more images corresponding to the one or more program. Further, the one or more programs includes a program to be rendered on a user device and/or a program being rendered on the user device. Furthermore, the user device includes a car infotainment system, a smartphone, and/or a smart home device. In an embodiment, the image content moderation system includes an image analysis module configured to analyze the one or more images for a potential offensive content. The image analysis module analyses the one or more images by utilizing Machine Learning (ML) and image recognition techniques to detect potential offensive content. In an embodiment, the image content moderation system includes a scoring module configured to assign a score to each image indicating a level of potential offensiveness. The scoring module assigns scores based on predefined criteria including racy, explicit material, violence, and/or hate symbols.

In an embodiment, the image content moderation system includes an information generation module configured to generate information describing the one or more images, such that the generated information along with the corresponding scores are rendered to a user of the user device for decision making pertaining to displaying of the one or more images. In an embodiment, the image content moderation system includes a decision module to determine whether to display the one or more images based at least on the selection of the user of the user device.

In an embodiment, the image content moderation system includes a threshold determination module to facilitate the user to set a moderation threshold based on preference for content filtering, such that the decision module automatically identifies and stops the displays of the one or more images which are potentially offensive if the corresponding assigned score is more than moderation threshold. Further, the image content moderation system includes an alternate image selection module to provide one or more alternate images that have been cleared of any potentially offensive content for display, by the decision module, in place of the one or more potentially offensive images. The alternate image selection module sources the one or more alternate images from the hybrid radio broadcasters and/or image catalog, along with the corresponding scores. In an embodiment, the image content moderation system includes a user interface module communicatively coupled to the decision module and configured to perform displaying the one or more images, blocking the one or more images, and/or replacing the one or more images with the one or more alternate images based the user selection and/or comparison of the assigned scores with the moderation threshold.

An embodiment of the present disclosure discloses the image content moderation method for hybrid radio broadcast. The image content moderation method includes the steps of receiving one or more programs along with associated metadata through hybrid radio broadcast on a user device. The received metadata includes at least one or more images corresponding to the one or more program. Further, the one or more programs includes a program to be rendered on a user device and/or a program being rendered on the user device. Furthermore, the user device includes a car infotainment system, a smartphone, and/or a smart home device. In an embodiment, the image content moderation method includes the steps of analyzing the one or more images for a potential offensive content. The analyzation of the one or more images is done by utilizing Machine Learning (ML) and image recognition techniques to detect potential offensive content. In an embodiment, the image content moderation method includes the steps of assigning a score to each image indicating a level of potential offensiveness. The scores are assigned based on predefined criteria including racy, explicit material, violence, and/or hate symbols.

In an embodiment, the image content moderation method includes the steps of generating information describing the one or more images, such that the generated information along with the corresponding scores are rendered to a user of the user device for decision making pertaining to displaying of the one or more images. In an embodiment, the image content moderation method includes the steps of determining whether to display the one or more image based at least on the selection of the user of the user device.

In an embodiment, the image content moderation method includes the steps of facilitating the user to set a moderation threshold based on preference for content filtering, such that the identifying and stopping the displays of the one or more images which are potentially offensive is performed automatically if the corresponding assigned score is more than moderation threshold. Further, the image content moderation method includes the steps of providing one or more alternate images that have been cleared of any potentially offensive content for display in place of the one or more potentially offensive images. The one or more alternate images are sourced from the hybrid radio broadcasters and/or image catalog, along with the corresponding scores. In an embodiment, the image content moderation method includes the steps of displaying the one or more images, blocking the one or more images, and/or replacing the one or more images with the one or more alternate images based the user selection and/or comparison of the assigned scores with the moderation threshold.

An embodiment of the present disclosure discloses the computer program product comprising at least one non-transitory computer-readable storage medium having computer-executable program code portions stored therein. The computer program product is configured to receive one or more programs along with associated metadata through hybrid radio broadcast on a user device. The received metadata includes at least one or more images corresponding to the one or more program. Further, the one or more programs includes a program to be rendered on a user device and/or a program being rendered on the user device. Furthermore, the user device includes a car infotainment system, a smartphone, and/or a smart home device. In an embodiment, the computer program product is configured to analyze the one or more images for a potential offensive content. The analyzation of the one or more images is done by utilizing Machine Learning (ML) and image recognition techniques to detect potential offensive content. In an embodiment, the computer program product is configured to assign a score to each image indicating a level of potential offensiveness. The scores are assigned based on predefined criteria including racy, explicit material, violence, and/or hate symbols.

In an embodiment, the computer program product is configured to generate information describing the one or more images, such that the generated information along with the corresponding scores are rendered to a user of the user device for decision making pertaining to displaying of the one or more images. In an embodiment, the computer program product is configured to determine whether to display the one or more image based at least on the selection of the user of the user device.

In an embodiment, the computer program product is configured to facilitate the user to set a moderation threshold based on preference for content filtering, such that the identifying and stopping the displays of the one or more images which are potentially offensive is performed automatically if the corresponding assigned score is more than moderation threshold. Further, the computer program product is configured to provide one or more alternate images that have been cleared of any potentially offensive content for display in place of the one or more potentially offensive images. The one or more alternate images are sourced from the hybrid radio broadcasters and/or image catalog, along with the corresponding scores. In an embodiment, the computer program product is configured to display the one or more images, blocking the one or more images, and/or replacing the one or more images with the one or more alternate images based on the user selection and/or comparison of the assigned scores with the moderation threshold.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment having an image content moderation system for hybrid radio broadcast, in accordance with an embodiment of the present disclosure.

FIG. 2 illustrates a block diagram of the image content moderation system for hybrid radio broadcast, in accordance with an embodiment of the present disclosure.

FIG. 3 illustrates an exemplary user device for receiving hybrid radio broadcast, in accordance with an embodiment of the present disclosure.

FIG. 4A-4C illustrate exemplary implementation of the image content moderation system, in accordance with an embodiment of the present disclosure.

FIG. 5A-5C illustrates another exemplary implementation of the image content moderation system, in accordance with an embodiment of the present disclosure.

FIG. 6 illustrates a flow chart for an operation of the image content moderation system, in accordance with an embodiment of the present disclosure.

FIG. 7 is a flow chart of an image content moderation method for hybrid radio broadcast, in accordance with an embodiment of the present disclosure.

FIG. 8 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, optical disks, compact disc read-only memories (CD-ROMs), and magneto-optical disks, semiconductor memories, such as ROMs, PROMs, random access memories (RAMs), programmable read-only memories (PROMs), crasable PROMs (EPROMs), electrically crasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to an image content moderation system, method, and a computer program product (hereinafter may also be termed “mechanism”) for hybrid radio broadcast. The disclosed mechanism in the present disclosure provides a sophisticated image content moderation solution tailored for hybrid radio broadcasts, addressing the critical need to ensure that visual content transmitted alongside audio broadcasts remains appropriate and non-offensive for all users. The disclosed mechanism is designed to seamlessly integrate with existing broadcast transmissions, collecting programs and associated metadata, including images, which are then transmitted to user devices such as car infotainment systems, smartphones, and smart home devices. Upon receiving these images, the disclosed mechanism may employ advanced machine learning and image recognition techniques to meticulously analyze the content for potential offensiveness. This comprehensive analysis may categorize images based on various criteria, such as racy or explicit material, violence, and hate symbols. Each image may be assigned a score reflecting its level of potential offensiveness, which is included as corresponding information. Such corresponding information along with the score may be rendered to the user to allow or block the display of the corresponding image. Additionally, or alternatively, the disclosed mechanism may also facilitate the users to set a moderation threshold according to their personal content filtering preferences which is then used to automatically determine whether to display, block, or replace the images. In cases where an image may be deemed potentially offensive, the disclosed mechanism may provide a non-offensive substitute image, ensuring that users receive appropriate content. The disclosed mechanism may operate in real-time, ensuring that the content moderation process does not introduce significant delays, thus maintaining the seamless delivery of hybrid radio broadcasts.

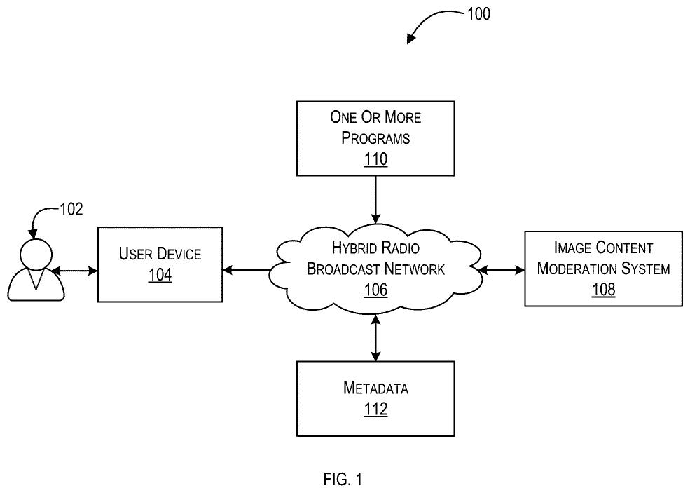

FIG. 1 illustrates an exemplary environment 100 having an image content moderation system 108 for hybrid radio broadcast, in accordance with an embodiment of the present disclosure. In an embodiment, the exemplary environment 100 may include a user 102, a user device 104, a hybrid radio broadcast network 106, the image content moderation system 108 (hereafter may also be referred to as “system 108”), one or more radio programs 110, and metadata 112. The user 102 may correspond to an end user who consumes multimedia content through hybrid radio services. This includes a diverse range of individuals, such as drivers utilizing car infotainment systems, who benefit from safe and non-distracting visual content while on the road. Tech-savvy individuals who rely on their smartphones for media consumption can also be users, leveraging the image content moderation system 108 to ensure that their experience remains family-friendly and free from offensive material. Smart home device users who integrate hybrid radio broadcasts into their home entertainment systems can also use the image content moderation system 108 to maintain an appropriate and pleasant audiovisual environment for all household members, including children. Accordingly, the user 102 may represent anyone who values control over the visual content they encounter in conjunction with their audio media, ensuring it aligns with their personal, familial, or societal standards. Accordingly, the user device 104 may correspond to any device capable of receiving and rendering hybrid radio broadcasts, such as a car infotainment system, smartphone, and/or smart home device. The user device 104 may receive radio programs and associated metadata, process the content, and renders it to the user. It also includes user interface components for setting preferences and thresholds.

In an embodiment, the hybrid radio broadcast network 106 may correspond to an advanced broadcasting system that seamlessly integrates traditional radio transmission with internet-based digital content delivery. The hybrid radio broadcast network 106 may leverage the strengths of both analog and digital technologies to provide a rich and interactive listening experience. Thus, traditional radio signals may be used for broadcasting audio content, ensuring broad and reliable coverage even in areas with limited internet connectivity. Concurrently, the internet component of the hybrid radio broadcast network 106 may allow for the transmission of supplementary digital content, such as metadata 112, images, and interactive features, enhancing the overall user experience. This hybrid approach not only improves the quality and diversity of content available to listeners but also enables real-time updates and personalization based on user preferences. By combining the ubiquity and dependability of conventional radio with the versatility and interactivity of digital media, the hybrid radio broadcast network 106 may offer a robust and dynamic platform for modern multimedia consumption. The image content moderation system 108 may be responsible for analyzing, scoring, and moderating images associated with radio programs and may ensure that only appropriate images are displayed to the user 102 by assigning offensiveness scores and offering alternative images if necessary.

In an embodiment, the one or more radio programs 110 within the hybrid radio broadcast network 106 may encompass a wide variety of audio content, ranging from music and talk shows to news broadcasts and educational segments. These programs may be crafted to cater to diverse audience preferences, providing entertainment, information, and engagement. The hybrid nature of the broadcast may allow these programs to not only deliver high-quality audio but also enhance the listening experience with additional digital content. For instance, a music program can include high-definition album covers, artist bios, and lyrics, enriching the listener's interaction with the music. Talk shows and news programs may be accompanied by real-time updates, images of speakers, and relevant infographics, offering a more immersive and informative experience. This dynamic combination of audio and visual content may ensure that radio programs are more than just auditory experiences-they become multifaceted media events that engage listeners on multiple levels. The metadata 112 may play a crucial role in this enriched broadcasting environment and may refer to the supplementary information transmitted alongside the audio content, providing context and additional layers of information to the one or more radio programs 110. The metadata 112 may include textual descriptions, visual elements such as images and graphics, and other relevant data that enhance the listener's understanding and enjoyment of the program. In a hybrid radio broadcast, the metadata 112 may serve multiple functions. For music programs, the metadata 112 may include the song title, artist name, album information, and accompanying album cover art. For talk shows or news programs, it could provide speaker names, topics of discussion, related images, and links to further information. This additional content helps create a more interactive and engaging user experience.

In operation, the radio station may broadcast the one or more radio programs 110 over the hybrid radio broadcast network 106. The broadcast may include both the audio content and metadata 112, which may contain images related to the one or more radio program 110. Accordingly, the user device 104 may receive the broadcast, including the metadata 112, and forward the images from the metadata 112 to the image content moderation system 108 for analysis. The image content moderation system 108 may analyze the images using advanced techniques such as machine learning and image recognition to identify any potentially offensive content and assign a score to each image based on predefined criteria such as explicit material, violence, and hate symbols. Then, the image content moderation system 108 may generate a detailed information about each image, including the assigned offensiveness scores. This information may then be rendered on the user device 104, where the user 102 can review it. The user 102 may set a moderation threshold through the user device's interface, specifying their preferences for content filtering. Based on the user's threshold settings, the image content moderation system 108 may determine whether to display the original images, block them, or replace them with non-offensive alternate images. If an image's score exceeds the user's threshold, the system 108 may select and display a pre-approved alternate image instead. Accordingly, the final decision on which images to display is executed on the user device 104. The user 102 can see either the original images, if they are deemed appropriate, or the alternate images provided by the image content moderation system 108. This ensures that the content displayed to the user 102 aligns with their preferences and is free from potentially offensive material.

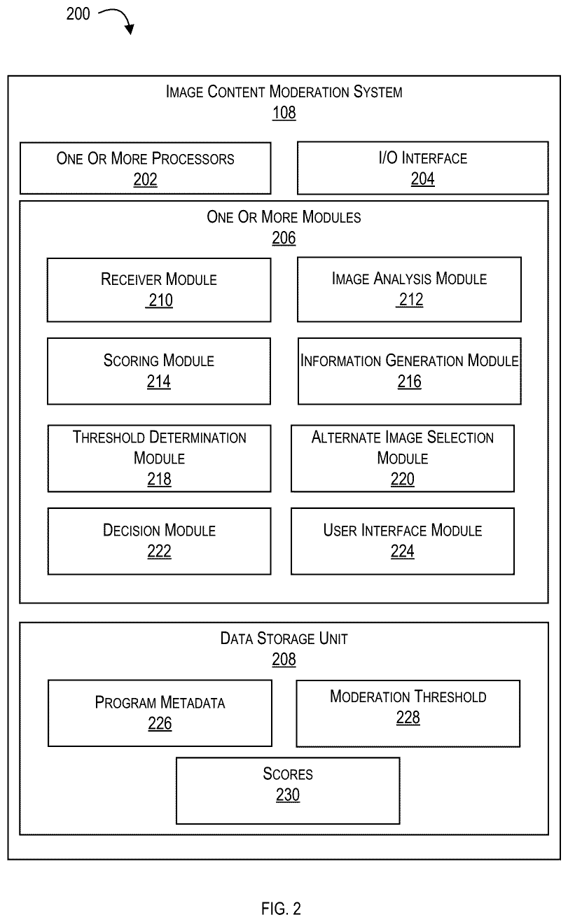

FIG. 2 illustrates a block diagram 200 of the image content moderation system 108 for hybrid radio broadcast, in accordance with an embodiment of the present disclosure.

In an embodiment, the system 108 may include one or more processors 202, an Input/Output (I/O) interface 204, one or more modules 206, and a data storage unit 208. The one or more processors 202 may be implemented as one or more microprocessors microcomputers, microcomputers, digital signal processors, central processing units, state machines, logic circuitries, and/or any devices that manipulate signals based on operational instructions. Further, the I/O interface 204 may serve as the pivotal bridge connecting the internal processes of the system 108 with its external environment for facilitating the exchange of information between the system 108 and its users or external devices. Furthermore, the I/O interface 204 may contribute to the user experience by providing intuitive means for input, such as through keyboards or touchscreens, and presenting meaningful output via displays or other output devices. In an embodiment, the one or more modules 206 may include a receiver module 210, an image analysis module 212, a scoring module 214, an information generation module 216, a threshold determination module 218, an alternate image selection module 220, a decision module 222, and a user interface module 224, and any other module essential or required for the working of the system 108. In an embodiment, the data storage unit 208 may store program metadata 226 (may be similar to or same as metadata 112), a moderation threshold 228, and one or more scores 230 required for the working of the system 108. In an embodiment of the present disclosure, the one or more processors 202 and the data storage unit 208 may form a part of a chipset installed in the system 108. In another embodiment of the present disclosure, the data storage unit 208 may be implemented as a static memory or a dynamic memory. In an example, the data storage unit 208 may be internal to the system 108, such as an onside-based storage. In another example, the data storage unit 208 may be external to the system 108, such as cloud-based storage. Further, the one or more module 206 may be communicatively coupled to the data storage unit 208 and the one or more processor 202 of the system 108. The one or more processors 202 may be configured to control the operations of the one or more modules 206.

In an embodiment, the receiver module 210 may receive the one or more programs 110 along with the associated metadata 112 through the hybrid radio broadcast on the user device 104 such as, but not limited to, a car infotainment system, a smartphone, and a smart home device. The received metadata 112 includes at least one or more images corresponding to the one or more program 110. The one or more programs 110 may include a program to be rendered on the user device 104 and a program being rendered on the user device 104. Accordingly, the receiver module 210 may be responsible for capturing the incoming broadcast transmissions and associated metadata. The receiver module 210 may be designed to interface seamlessly with the hybrid radio broadcast network 106, effectively receiving both the traditional audio content and the supplementary digital data that accompanies it. By efficiently capturing the broadcasted programs and their metadata, the receiver module 210 may ensure that all relevant information, including images, descriptions, and contextual data, is available for further processing. Moreover, the receiver module 210 gathers comprehensive broadcast data ensuring that the system 108 functions accurately and provides a rich, moderated user experience on various user devices 104.

In an embodiment, the image analysis module 212 may analyze the one or more images by scrutinizing and evaluating for a potential offensive content. The image analysis module 212 may employ advanced technologies, such as machine learning and image recognition algorithms, to thoroughly analyze the visual content to detect potential offensive content by assessing various aspects of the images, including explicit material, violent content, racy elements, and hate symbols. The image analysis module 212 detects and flags inappropriate content in real-time and may allow the system 108 to proactively manage and moderate the images, ensuring that only suitable visuals are presented to the user 102. In an embodiment, the image analysis module 212 may enhance the safety and appropriateness of the content displayed by aligning with user preferences and societal standards for decency and appropriateness.

In an embodiment, the scoring module 214 may quantify the level of potential offensiveness in images analyzed by the image analysis module 212 to assign a score to each image indicating a level of potential offensiveness. The scoring module 214 may assign scores to images based on predefined criteria such as racy, explicit material, violence, and/or hate symbols. Such scores may reflect the degree of appropriateness of the visual content, enabling a standardized and objective measure for content evaluation. By translating the qualitative assessment from the image analysis into a quantitative score, the scoring module 214 may facilitate precise and consistent moderation decisions. This scoring approach may allow the users 102 to set their own moderation thresholds, ensuring that the content displayed aligns with their personal or community standards.

In an embodiment, the information generation module 216 may serve as the bridge between the technical analysis of images and the user-facing decision-making process within the image content moderation system 108. The information generation module 216 may compile and organize the data derived from the image analysis module 212 and the scoring module 214 to generate comprehensive description of each image. Accordingly, the generated information along with the corresponding scores may be rendered to the user 102 of the user device 104 for decision making pertaining to displaying of the one or more images. In an embodiment, such information may include the assigned offensiveness scores, descriptions of the detected content, and any relevant contextual information. By transforming raw analytical data into user-friendly information, the information generation module 216 may enable the users 102 to make informed decisions regarding image display. As a result, the information generation module 216 may ensure that all pertinent details are conveyed clearly and concisely, allowing the users 102 to understand why certain images have been flagged and to adjust their moderation settings accordingly. Further, by presenting such information in an accessible format, the information generation module 216 may maintain transparency and control, empowering the users 102 to customize their content experience based on their individual preferences and sensitivity to offensive material.

In an embodiment, the threshold determination module 218 may empower users to tailor the content filtering process according to their personal and/or community standards. The threshold determination module 218 may allow the users 102 to set a moderation threshold, which serves as a benchmark for determining whether an image should be displayed, blocked, or replaced with an alternate image. Such moderation threshold may be set based on preference for content filtering and/or community standards. By enabling the users 102 to define their own tolerance levels for potentially offensive content, the threshold determination module 218 may ensure a personalized and flexible user experience. Further, the threshold determination module 218 may interact seamlessly with the scoring module 214, comparing the offensiveness scores of images against the user-defined threshold. If an image's score exceeds the set threshold, the system 108 may take appropriate action based on the user's preferences, such as, but not limited to, automatically identifying and stopping the display of the one or more images, by the decision module 222, which are potentially offensive if the corresponding assigned score is more than moderation threshold.

In an embodiment, the alternate image selection module 220 may provide one or more alternate images that have been cleared of any potentially offensive content for display, by the decision module 222, in place of the one or more potentially offensive images, as may be described in details in following paragraphs. Further, the alternate image selection module 220 may source the one or more alternate images from the hybrid radio broadcasters and/or image catalog, along with the corresponding scores ensuring a seamless and contextually relevant replacement. Accordingly, the alternate image selection module 220 may enhance the user experience by providing non-offensive substitutes for images that exceed the user-defined moderation threshold. When an image is flagged as potentially inappropriate, the alternate image selection module 220 may identify and select alternative images that have been pre-approved and cleared of any offensive content. The alternate image selection module 220 may provide visually appropriate alternatives while maintaining the aesthetic and informational value of the broadcast without exposing the users 102 to harmful and/or disturbing content. This feature may be particularly beneficial for environments where maintaining appropriateness is crucial, such as family settings and/or public spaces and the alternate image selection module 220 may play a vital role in upholding the integrity of the broadcast while respecting the diverse sensitivities of the audience.

In an embodiment, the decision module 222 may determine whether to display the one or more images based at least on the selection of the user of the user device 104. Further, the decision module 222 may integrate the various inputs and outputs of the image content moderation system 108 to execute the final action on image display. The decision module 222 may process the information generated by the image analysis, scoring, and threshold determination modules, making real-time decisions on whether to display, block, or replace an image based on its offensiveness score and the user-defined moderation threshold. The decision module 222 may ensure that the user's preferences and settings are respected and applied consistently across all received images. By dynamically evaluating each image against the user's content sensitivity settings, the decision module 222 may enhance the user experience by delivering appropriate visual content without interruptions. Additionally, the decision module 222 may coordinate with the alternate image selection module 220 to substitute flagged images with non-offensive alternatives seamlessly.

In an embodiment, the user interface module 224 may provide an intuitive and accessible platform for the users 102 to interact with and control the system's functionalities. The user interface module 224 may enable users to set their moderation preferences, adjust thresholds, and review flagged content through a clear and straightforward interface. Further, the user interface module 224 may present the metadata 112 and offensiveness scores generated by the system 108 in an easily understandable format, allowing users to make informed decisions about image display. Additionally, the user interface module 224 may be communicatively coupled to the decision module 222 and may be configured to perform displaying the one or more images, blocking the one or more images, and/or replacing the one or more images with the one or more alternate images based on the user selection and/or comparison of the assigned scores with the moderation threshold.

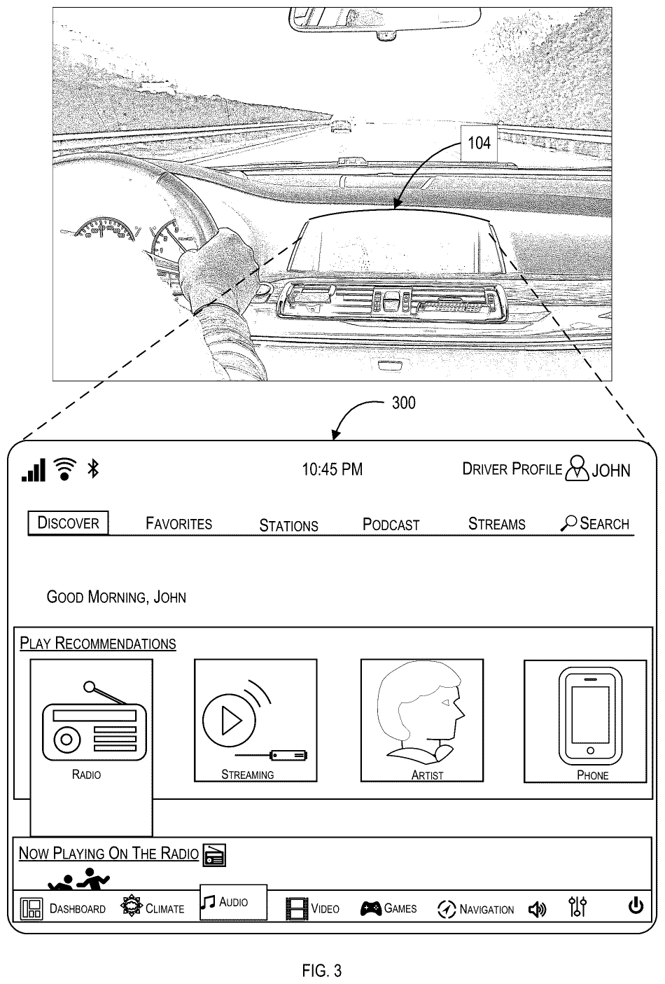

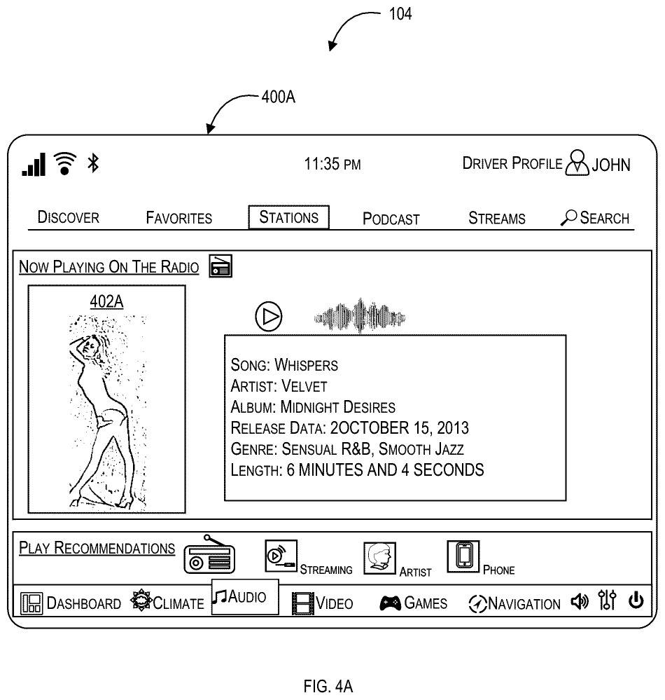

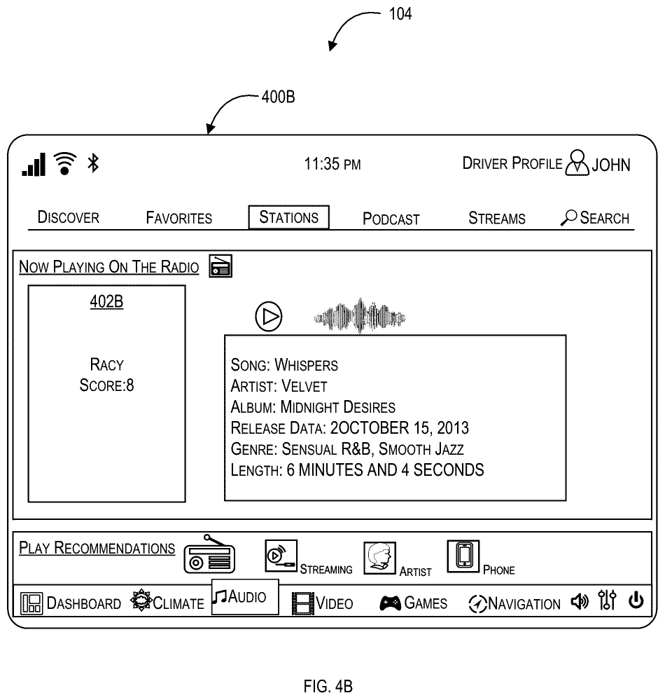

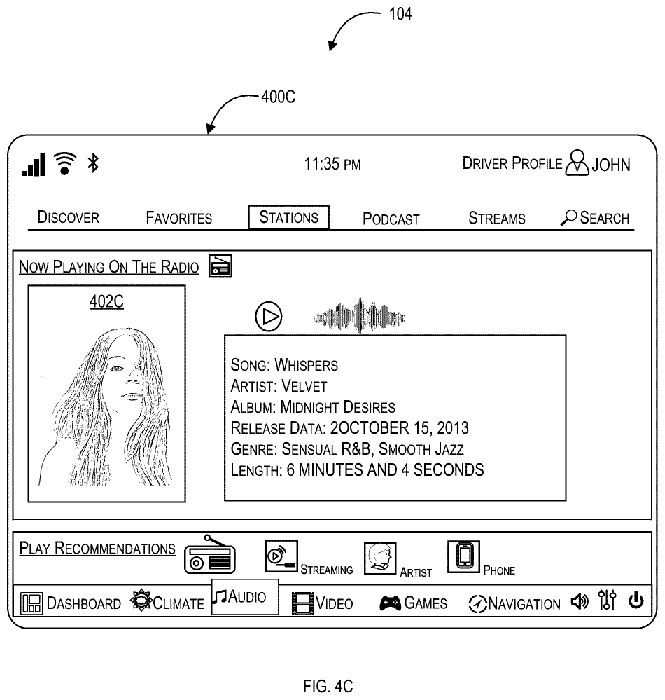

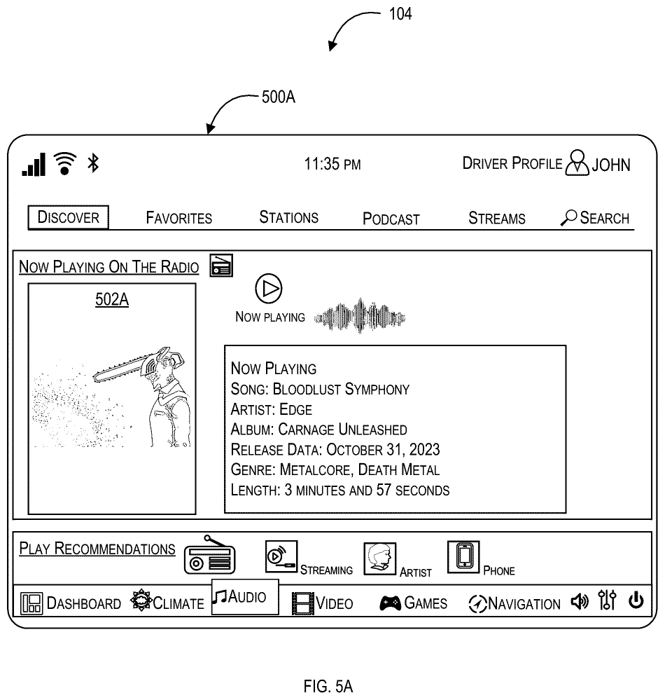

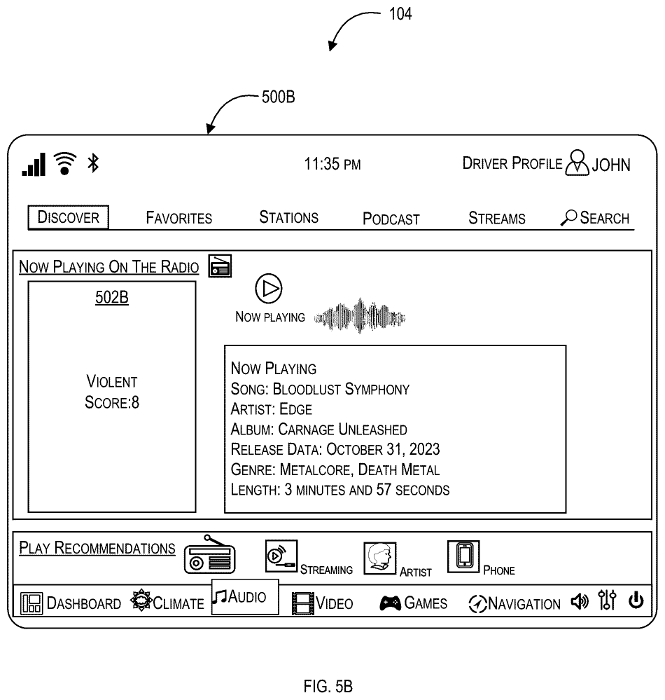

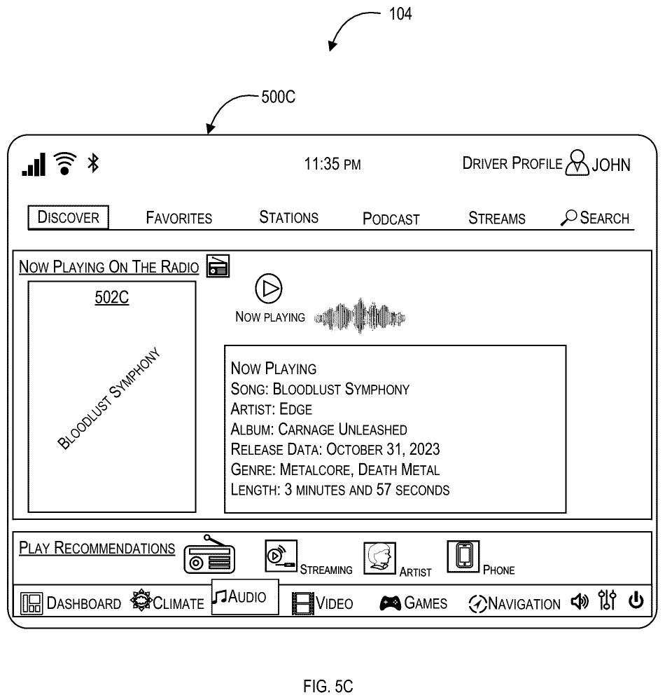

FIG. 3 illustrates an exemplary user device 104 for receiving hybrid radio broadcast, in accordance with an embodiment of the present disclosure. FIG. 4A-4C illustrate exemplary implementation of the image content moderation system 108, in accordance with an embodiment of the present disclosure. FIG. 5A-5C illustrates another exemplary implementation of the image content moderation system 108, in accordance with an embodiment of the present disclosure.

As shown in FIG. 3, the user device 104, i.e., the vehicle dashboard, may display the user's profile with various options, such as stations, podcasts, recommendations, or the like. Further, the user 102 may have a choice to select the radio to listen to, a streaming service, an artist, or the like. Furthermore, as illustrated in the user interface 300, the user 102 may select the radio (i.e., hybrid radio broadcast), such that the user device 104 may start playing the radio and may render corresponding icons on the interface such as “now playing on the radio”. After the user 102 selects the radio option for playing, the user 102 may be facilitated to select from the one or more radio broadcasters/stations/programs. In an exemplary embodiment, the selection radio program may include a popular song i.e., whispers by Velvet from album Midnight Desires (one of the radio programs 110), and an image of the album cover 402A (the metadata 112) i.e. a woman wearing revealing attire. It may be apparent to a person skilled in the art that the existing solutions may display the image of the album cover as is, as illustrated in the user interface 400A in FIG. 4A. However, the image content moderation system 108 may receive the album cover image and analyze it. Since the album cover contains explicit material, the system 108 may assign a high offensiveness score to the image and display such score to the user 102, as shown by the box 402B in the user interface 400B of FIG. 4B. Thus, the system 108 may facilitate the user 102 in making a choice to whether to display the image or block the image. In an embodiment, the user 102 may request displaying of an alternate image 402C, as shown in user interface 400C in FIG. 4C. In another embodiment, the system 108 may automatically display the alternate image 402C based on a moderate threshold for offensive content set by the user 102. Based on such threshold, the system 108 may determine that the album cover should not be displayed and the system 108 may find an alternate image, perhaps the artist's portrait, which is deemed non-offensive. The car infotainment system may then display the artist's portrait instead of the explicit album cover, ensuring a safe and comfortable user experience while maintaining the context of the broadcast.

In another exemplary embodiment, the selection radio program may include another popular song i.e., Bloodlust Symphony by Edge from album Carnage Unleashed (one of the radio programs 110), and an image of the album cover 502A (the metadata 112) i.e. chainsaw and blood. It may be apparent to a person skilled in the art that the existing solutions may display the image of the album cover as is, as illustrated in the user interface 500A in FIG. 5A. However, the image content moderation system 108 may receive the album cover image and analyze it. Since the album cover contains violent material, the system 108 may assign a high violent score to the image and display such scores to the user 102, as shown by the box 502B in the user interface 500B of FIG. 5B. Thus, the system 108 may facilitate the user 102 in making a choice to whether to display the image or block the image. In an embodiment, the user 102 may request displaying of an alternate image but the alternate image may not be available. In such scenario, as shown by box 502C in user interface 500C in FIG. 5C, the system 108 may display other metadata such as, but not limited to, name of the program, logo of the artist, initials of the program/artist. In another embodiment, the system 108 may automatically display such metadata 502C based on a moderate threshold for offensive content set by the user 102. Based on such threshold, the system 108 may determine that the album cover should not be displayed and the system 108 may make an attempt to find an alternate image (which may not be available) and may generate the metadata 502C to display to the user 102. The car infotainment system may then display the metadata 502C instead of the explicit album cover, ensuring a safe and comfortable user experience while maintaining the context of the broadcast.

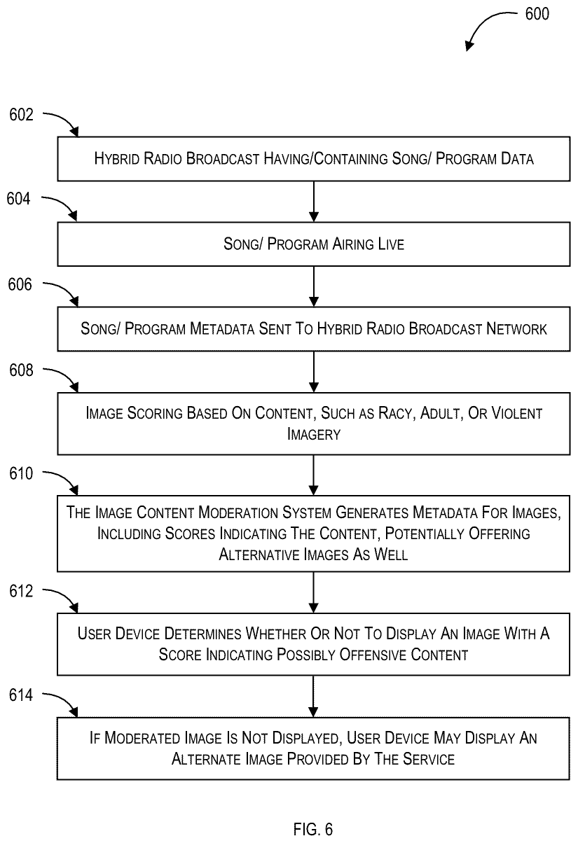

FIG. 6 illustrates a flow chart 600 for an operation of the image content moderation system, in accordance with an embodiment of the present disclosure. At first, at step 602, a song or program may be prepared and stored within broadcaster's automation system. The broadcast automation system may be responsible for scheduling and managing the playback of audio content and may ensure that the song or program is ready for broadcast, along with any associated metadata, such as title, artist, and album information, as well as any accompanying images like album covers or promotional graphics. Next, at step 604, once the broadcast automation system schedules the song or program for airing, it may be played on-air through the hybrid radio broadcast network 106. The audio content may be transmitted to listeners in real-time, utilizing traditional radio frequencies as well as digital signals to reach a broad audience. During this process, the associated metadata, including images, may also be prepared for transmission to hybrid radio clients. Next, at step 606, as the song or program is broadcast, its metadata, including any associated images, may be sent to the hybrid radio broadcast network 106. The hybrid radio broadcast network 106 may be a part of the hybrid radio infrastructure that collects and processes incoming metadata from the broadcaster and ensures that all relevant information, such as song details and images, is captured accurately for further processing. Once the metadata and images are ingested, the system 108 may begin the process of inspecting the images for content moderation purposes by analyzing the images for potentially offensive content by advanced algorithms and machine learning techniques to detect explicit material, violence, racy elements, and hate symbols within the images.

Next, at step 608, after analyzing the images, the images may be assigned a score based on the detected content and such score may reflect the level of potential offensiveness, categorized by criteria such as raciness, explicit material, violence, or hate symbols. The scoring process may standardize the evaluation of images, providing a consistent measure of their appropriateness. Next, at step 610, after the images are scored, the hybrid radio metadata service may generate comprehensive metadata that may include the original images, their corresponding offensiveness scores, and/or potentially any alternate images that have been cleared of offensive content. Next, at step 612, based on the user-defined moderation threshold, the hybrid radio client may evaluate the scores of incoming images. If an image's score exceeds the set threshold, indicating it is potentially offensive, the system 108 may decide not to display it and ensure that users 102 are protected from viewing inappropriate content. Thereafter, at step 614, when an image is flagged as inappropriate and not displayed, the hybrid radio client may choose an alternate image provided by the metadata service. Such alternate images may be pre-approved and free from offensive content, ensuring that the visual component of the broadcast remains suitable for all users.

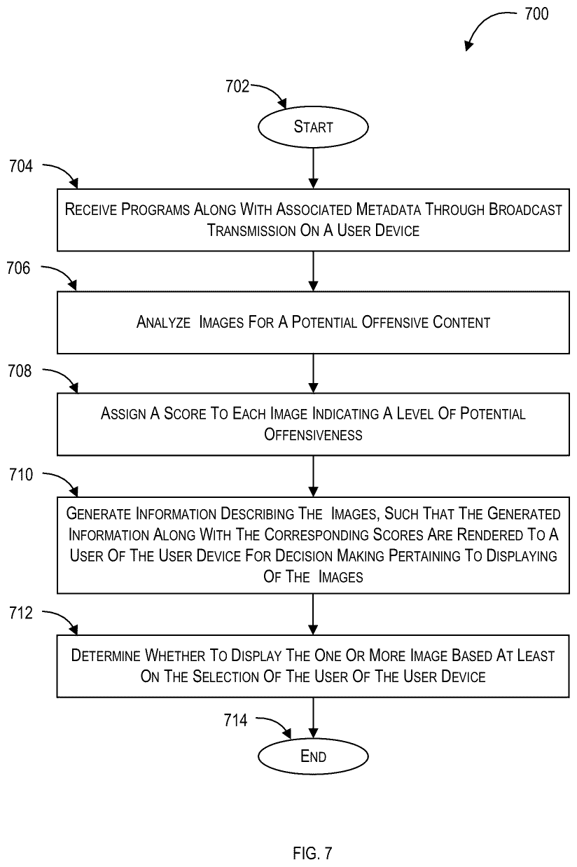

FIG. 7 is a flow chart 700 of an image content moderation method for hybrid radio broadcast, in accordance with an embodiment of the present disclosure. The method starts at step 702.

At first, at step 704, one or more programs may be received along with associated metadata through hybrid radio broadcast on a user device. The received metadata may include at least one or more images corresponding to the one or more program. Further, the one or more programs may include a program to be rendered on the user device and/or a program being rendered on the user device. Furthermore, the user device may include a car infotainment system, a smartphone, and/or a smart home device. Next, at step 706, the one or more images may be analyzed for a potential offensive content. The analyzation of the one or more images may be done by utilizing Machine Learning (ML) and image recognition techniques to detect potential offensive content.

Next, at step 708, a score may be assigned to each image indicating a level of potential offensiveness. The scores may be assigned based on predefined criteria including racy, explicit material, violence, and/or hate symbols. Next, at step 710, information describing the one or more images may be generated, such that the generated information along with the corresponding scores are rendered to a user of the user device for decision making pertaining to displaying of the one or more images. Thereafter, at step 712, whether to display the one or more image may be determined based at least on the selection of the user of the user device.

In an embodiment, the image content moderation method may include the steps of facilitating the user to set a moderation threshold based on preference for content filtering, such that the identifying and stopping the displays of the one or more images which are potentially offensive is performed automatically if the corresponding assigned score is more than moderation threshold. Further, the image content moderation method may include the steps of providing one or more alternate images that have been cleared of any potentially offensive content for display in place of the one or more potentially offensive images. The one or more alternate images may be sourced from the hybrid radio broadcasters and/or image catalog, along with the corresponding scores. In an embodiment, the image content moderation method may include the steps of displaying the one or more images, blocking the one or more images, and/or replacing the one or more images with the one or more alternate images based on the user selection and/or comparison of the assigned scores with the moderation threshold. The method ends at step 714.

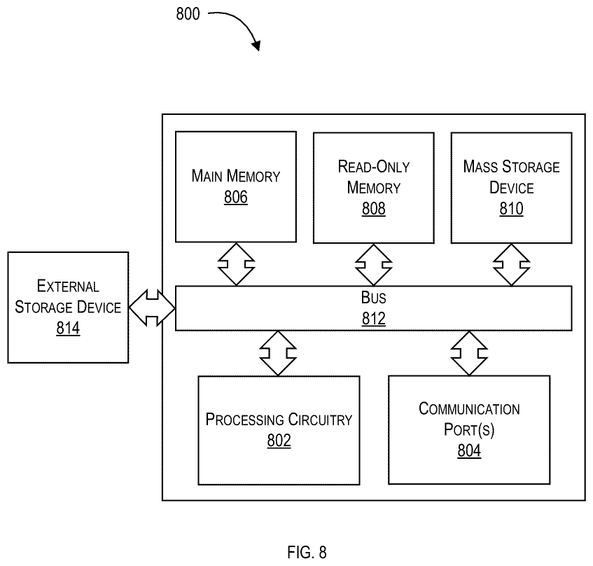

FIG. 8 illustrates an exemplary computer system in which or with which embodiments of the present disclosure may be utilized. As shown in FIG. 8, a computer system 800 includes an external storage device 814, a bus 812, a main memory 806, a read-only memory 808, a mass storage device 810, a communication port 804, and a processor 802.

Those skilled in the art will appreciate that computer system 800 may include more than one processor 802 and communication ports 804. Examples of processor 802 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 802 may include various modules associated with embodiments of the present disclosure.

The communication port 804 can be any of an RS-232 port for use with a modem-based dialup connection, a 10/100 Ethernet port, a Gigabit or 10 Gigabit port using copper or fiber, a serial port, a parallel port, or other existing or future ports. The communication port 804 may be chosen depending on a network, such as a Local Area Network (LAN), Wide Area Network (WAN), or any network to which the computer system connects.

The memory 806 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 802.

The mass storage 810 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCic, Nexsan Technologies, Inc. and Enhance Technology, Inc.

The bus 812 communicatively couples processor(s) 802 with the other memory, storage, and communication blocks. The bus 812 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 802 to a software system.

Optionally, operator and administrative interfaces, e.g., a display, keyboard, and a cursor control device, may also be coupled to bus 812 to support direct operator interaction with the computer system. Other operator and administrative interfaces can be provided through network connections connected through communication port 804. An external storage device 814 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

The disclosed system, method, and computer program product (together termed as ‘disclosed mechanism’) for image content moderation tailored for hybrid radio broadcasts offers a tailored solution that enhances user control and content filtering. By seamlessly receiving, analyzing, and scoring images accompanying broadcasted programs, the mechanism effectively anticipates and identifies potentially offensive content, thereby significantly enhancing user satisfaction and contentment. Leveraging advanced Machine Learning (ML) algorithms and sophisticated image recognition techniques, the mechanism ensures precise detection of inappropriate material, fostering a more secure and enjoyable user experience. Moreover, its dynamic decision-making process enables adaptable image display, allowing users to customize their content consumption based on personal preferences or predefined moderation thresholds. Furthermore, the mechanism offers alternative images devoid of offensive content and adds an extra layer of assurance, bolstering user satisfaction. Additionally, the mechanism's dynamic decision-making capabilities enable swift action to be taken, ensuring that only appropriate and safe visual content is delivered, thus mitigating the risk of exposure to undesirable material.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, arc not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used cuphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art

What is claimed is:

1. An image content moderation system for hybrid radio broadcast, the system comprising:
a receiver module to receive one or more programs along with associated metadata through the hybrid radio broadcast on a user device, wherein the received metadata includes at least one or more images corresponding to the one or more program;
an image analysis module configured to analyze the one or more images for a potential offensive content;
a scoring module configured to assign a score to each image indicating a level of potential offensiveness;
an information generation module configured to generate information describing the one or more images, such that the generated information along with the corresponding scores are rendered to a user of the user device for decision making pertaining to displaying of the one or more images; and
a decision module to determine whether to display the one or more image based at least on the selection of the user of the user device.

2. The system of claim 1, wherein the one or more programs includes at least one of: a program to be rendered on the user device and a program being rendered on the user device.

3. The system of claim 1, wherein the image analysis module analyses the one or more images by utilizing Machine Learning (ML) and image recognition techniques to detect potential offensive content.

4. The system of claim 1, wherein the scoring module assigns scores based on predefined criteria including at least one of: racy, explicit material, violence, and hate symbols.

5. The system of claim 1, further comprises a threshold determination module to facilitate the user to set a moderation threshold based on preference for content filtering, such that the decision module automatically identifies and stops the displays of the one or more images which are potentially offensive if the corresponding assigned score is more than moderation threshold.

6. The system of claim 5, further comprises an alternate image selection module to provide one or more alternate images that have been cleared of any potentially offensive content for display, by the decision module, in place of the one or more potentially offensive images.

7. The system of claim 6, wherein the alternate image selection module sources the one or more alternate images from at least one of: the hybrid radio broadcasters and image catalog, along with the corresponding scores.

8. The system of claim 7, further comprises a user interface module communicatively coupled to the decision module and configured to perform at least one of: displaying the one or more images, blocking the one or more images, and replacing the one or more images with the one or more alternate images based at least on one of: the user selection and comparison of the assigned scores with the moderation threshold.

9. The system of claim 1, wherein the user device includes at least one of: a car infotainment system, a smartphone, and a smart home device.

10. An image content moderation method for hybrid radio broadcast, the method comprising:
receiving one or more programs along with associated metadata through the hybrid radio broadcast on a user device, wherein the received metadata includes at least one or more images corresponding to the one or more program;
analyzing the one or more images for a potential offensive content;
assigning a score to each image indicating a level of potential offensiveness;
generating information describing the one or more images, such that the generated information along with the corresponding scores are rendered to a user of the user device for decision making pertaining to displaying of the one or more images; and
determining whether to display the one or more image based at least on the selection of the user of the user device.

11. The method of claim 10, wherein the one or more programs includes at least one of: a program to be rendered on the user device and a program being rendered on the user device.

12. The method of claim 11, further comprises analysing the one or more images by utilizing Machine Learning (ML) and image recognition techniques to detect potential offensive content.

13. The method of claim 11, further comprises assigning scores based on predefined criteria including at least one of: racy, explicit material, violence, and hate symbols.

14. The method of claim 11, further comprises facilitating the user to set a moderation threshold based on preference for content filtering, such that identifying and stopping the displays of the one or more images which are potentially offensive is done automatically if the corresponding assigned score is more than moderation threshold.

15. The method of claim 11, further comprises providing one or more alternate images that have been cleared of any potentially offensive content for display, by the decision module, in place of the one or more potentially offensive images.

16. The method of claim 11, further comprises sourcing the one or more alternate images from at least one of: the hybrid radio broadcasters and image catalog, along with the corresponding scores.

17. The method of claim 11, further comprises performing at least one of: displaying the one or more images, blocking the one or more images, and replacing the one or more images with the one or more alternate images based at least on one of: the user selection and comparison of the assigned scores with the moderation threshold.

18. The method of claim 11, wherein the user device includes at least one of: a car infotainment system, a smartphone, and a smart home device.

19. A computer program product comprising at least one non-transitory computer-readable storage medium having computer-executable program code portions stored therein, the computer program product configured to:
receive one or more programs along with associated metadata through the hybrid radio broadcast on a user device, wherein the received metadata includes at least one or more images corresponding to the one or more program;
analyze the one or more images for a potential offensive content;
assign a score to each image indicating a level of potential offensiveness;
generate information describing the one or more images, such that the generated information along with the corresponding scores are rendered to a user of the user device for decision making pertaining to displaying of the one or more images; and
determine whether to display the one or more image based at least on the selection of the user of the user device.

20. The computer program product of claim 19, further comprises:
analysing the one or more images by utilizing Machine Learning (ML) and image recognition techniques to detect potential offensive content;
assigning scores based on predefined criteria including at least one of: racy, explicit material, violence, and hate symbols;
facilitating the user to set a moderation threshold based on preference for content filtering, such that identifying and stopping the displays of the one or more images which are potentially offensive is done automatically if the corresponding assigned score is more than moderation threshold;
providing one or more alternate images that have been cleared of any potentially offensive content for display, by the decision module, in place of the one or more potentially offensive images;
sourcing the one or more alternate images from at least one of: the hybrid radio broadcasters and image catalog, along with the corresponding scores;
performing at least one of: displaying the one or more images, blocking the one or more images, and replacing the one or more images with the one or more alternate images based at least on one of: the user selection and comparison of the assigned scores with the moderation threshold.
